(19) United States
(12) Patent Application Publication
(10) Pub. No.: US 2007/0072061 A1
(43) Pub. Date: Mar. 29, 2007

(54) Power supply unit and method for cooling battery contained therein

(76) Inventor: Hideo Shimizu, Kakogawa-city (JP)

Correspondence Address: WENDEROTH, LIND & PONACK, L.L.P., 2033 K STREET N. W., SUITE 800, WASHINGTON, DC, 20006-1021, US

(21) Appl. No.: 11/526,034

(22) Filed: Sep. 25, 2006

(30) Foreign Application Priority Data
Sep. 28, 2005 (JP) 283114/2005

(51) Int. Cl. H01M 10/50

(52) U.S. Cl. 429/62; 429/120; 429/50

(57) ABSTRACT

A method for cooling a battery is disclosed, in which a power supply unit includes a plurality of batteries disposed up and down (in a multi-tier manner) within a case, a fan for cooling the batteries by forcibly blowing cooling air from top to bottom within the case, a temperature sensor for detecting temperatures of the batteries, and a control circuit for controlling operation of the fan by means of a signal fed out of the temperature sensor. In the battery cooling method, when a battery temperature difference between the upper battery and the lower battery reaches above a set value as detected by the temperature sensor while the fan is in operation, the control circuit stops operation of the fan to cool the batteries through natural heat radiation.

### BACKGROUND OF THE INVENTION

1. Field of the Invention

The present invention relates to a power supply unit which self-contains a plurality of batteries within an outer case and a method for cooling the batteries contained in the power supply unit, and particularly to a power supply unit and a method in which the batteries disposed in an upper-and-lower, multi-tier manner are cooled down to a uniform temperature.

2. Description of the Related Art

power supply unit, which self-contains a plurality of batteries within a case, is primarily used as a power source for driving a motor mounted to an electric motor vehicle such as an electric car and a hybrid car, the latter being designed to travel optionally with an internal combustion engine or with an electric motor. A power supply unit used for this kind of application is designed to have a higher output voltage so that a large electricity may be supplied to a motor which requires a high power. In order to satisfy such a design need, a multitude of batteries are interconnected in series and contained in a holder case. For example, a currently commercially available power supply unit mounted to a hybrid car has hundreds of batteries interconnected in series to generate a high output voltage to an extent of several hundreds. Such power supply unit is designed to have five or six pieces of batteries interconnected in series to form a single battery module, and then a multitude of such battery modules are contained within a holder case.

Being mounted to an electric motor vehicle such as a hybrid car, the power supply unit discharges a large current to accelerate the motor when the vehicle needs a burst of speed, and the power supply unit is charged with a large current by means of a regenerative brake when the vehicle is slowed down or when the vehicle travels down on a slope. Such an operation may often cause the battery to be heated up to a considerably high temperature. In addition, when the battery is used under circumstances with higher temperatures like in summer, the battery temperature tends to be elevated to even higher degrees. In view of these factors, when a power supply unit contains a multitude of batteries within a holder case, it is vital to cool each of self-contained batteries efficiently and uniformly. This is because a variety of disadvantages is likely to occur when there exists a temperature difference between those many batteries to be cooled. For example, a battery having undergone a high temperature tends to be degraded, thus resulting in a smaller amount of real charge capacity for reaching a full charge. When a battery with a reduced amount of real charge capacity is interconnected in series to be charged and discharged with the same current, the battery is very likely to be overcharged or overdischarged. This happens when a full charge capacity and a full discharge capacity have become smaller. A battery is subjected to a remarkable decrease in its property or performance through an overcharge and overdischarge, so that a battery with a smaller, real amount of charge capacity is prompted to degradation at a very high speed. Especially when the battery temperature is elevated to higher degrees, the battery is even more likely to be degraded that much. For these reasons, when a power supply unit contains a multitude of batteries within a holder case, it is important to uniformly cool all the batteries so that a temperature irregularity may be prevented.

There has been developed a variety of battery structures for overcoming such disadvantages arising from the temperature irregularity. Refer to Unexamined Japanese Patent Application (Kokai) Nos. 2001-313090, 2002-50412, and 1999-329518.

### SUMMARY OF THE INVENTION

The power supply units, previously disclosed in Unexamined Japanese Patent Application Nos. 2001-313090 and 2002-50412, are both developed by the same applicant as in the present case. In these power supply units, a plurality of unit cells are linearly interconnected with each other to form a battery module, and a plurality of such battery modules are postured in parallel and contained within a holder case. Inside the holder case, the battery modules are cooled by forcibly blowing cooling air to intersect the length of the battery modules. The battery modules are disposed in two tiers in a direction of the cooling air. Furthermore, the respective power supply unit has a plurality of holder cases arranged and then contained in an outer case. The power supply unit is capable of adjusting an output voltage by changing the number of holder cases to be contained within the outer case. In addition, each individual holder case has a clearance provided to interface the battery modules contained within the holder case, for easier air distribution. The clearance for air distribution is meant for blowing the cooling air to cool the battery modules. Also in order to uniformly cool each individual battery module, there is a control member disposed between the battery modules arranged and contained along the direction of the blown air, so that the member may control a flow of the cooling air.

The power supply units thus structured are capable of uniformly cooling two-tier battery modules contained within a holder case. However, when battery modules are to be contained in three or more tiers within the holder case for reducing a total installation area, it becomes difficult or impossible to uniformly cool each individual battery module.

Unexamined Japanese Patent Application No. 1999-329518, on the other hand, describes a power supply unit which contains battery modules in three or more tiers within a holder case. In that power supply unit, a plurality of battery modules, being postured in parallel and separated along the direction of cooling air, are contained within the holder case in a multi-tier manner. With this power supply unit, the cooling air is forcibly blown in between the battery modules to cool the battery modules. Disadvantageously, however, such a cooling structure will make a cooling performance less effective for a battery module in the downstream than for battery module in the upstream, thus generating a higher temperature. To overcome such a shortcoming, the holder case has an air turbulence accelerator, such as a dummy battery unit, provided in the uppermost stream, so that a stream of cooling air coming into the holder case may be disturbed to allow the battery module in the upstream to be efficiently cooled. Also, the holder case has an auxiliary air intake provided intermediate of a cooling air path, which is so designed as to allow the cooling air in, and thus a cooling efficiency may be increased for a battery in the downstream.

In the above-described power supply unit, a cooling effect for the battery module in the downstream can certainly be enhanced by means of the air turbulence or by the cooling air which is taken in intermediately. With such structure, however, it is impossible to cool a total number of battery modules down to a uniform temperature.

The present invention has been made in order to solve such disadvantages. It is, therefore, an important object of the present invention to provide a power supply unit which can reduce a temperature difference among a plurality of batteries contained within a holder case in an upper-and-lower, multi-tier manner, so that a uniform cooling performance may be made available for upper and lower batteries.

The power supply unit in accordance with the present invention includes a plurality of batteries 1 disposed up and down within a case 2, a fan 3 for forcibly blowing cooling air from top to bottom within the case 2 to cool the batteries 1, a temperature sensor 4 for detecting a temperature of the batteries 1, and a control circuit 5 for controlling an on and off operation of the fan 3 by means of a signal fed out of the temperature sensor 4. The control circuit 5 detects the temperature difference between the upper battery 1 and the lower battery 1, as detected by the temperature sensor 4, to control the fan operation. While the fan is in operation, the control circuit 5 stops the fan operation when the temperature difference reaches above a set value, so that the batteries 1 are cooled under the effect of natural heat radiation.

Also, while the fan 3 is not in operation, the control circuit 5 starts operating the fan 3 when a temperature difference between the upper battery 1 and the lower battery 1, as detected by the temperature sensor 4, reaches above a set value, so that the batteries 1 are forcibly cooled by means of the cooling air blown by the fan 3.

In a method for cooling the battery in accordance with the present invention, the temperature sensor 4 detects temperatures of a plurality of batteries 1 disposed up and down within the case 2, the operation of the fan 3 is controlled by means of the battery temperature as detected by the temperature sensor 4, and the batteries 1 are cooled by the cooling air forcibly blown from top to bottom by the fan 3. In accordance with the battery cooling method, the fan operation is controlled, being based on the temperature difference between the batteries.

When the temperature difference between the upper battery 1 and the lower battery 1, as detected by the temperature sensor 4, reaches above a set value while the fan 3 is in operation, the fan 3 stops operation so that the batteries 1 are cooled under the effect of natural heat radiation. On the other hand, when the temperature difference reaches above a set value while the fan 3 is not in operation, the fan 3 starts operation so that the batteries 1 are forcibly cooled by means of the cooling air blown by the fan 3.

The above-described power supply unit and battery cooling method carry the advantage that the temperature difference between the batteries contained in an upper-and-lower, multi-tier manner within the holder case, especially the temperature difference between the top and bottom batteries, can be reduced to minimum so that the upper and lower batteries are uniformly cooled. This is made possible because the fan is switched into or out of operation so that the temperature difference is minimized through switching the fan for the upper or lower batteries to be efficiently cooled. While the fan is in operation, the cooling air is blown from top to bottom to efficiently perform a cooling operation for the upper battery. While the fan is not in operation, natural convection caused by natural heat radiation works to efficiently cool the lower battery. Thus, when the temperature is elevated in the lower battery while the fan is in operation, the fan stops operation to cool the lower battery more efficiently than the upper battery, thus minimizing the temperature difference. When the temperature is elevated in the upper battery while the fan is not in operation, the fan starts operation to cool the upper battery more efficiently than the lower battery, thus minimizing the temperature difference.

The above and further objects and features of the invention will become more fully apparent from the following detailed description taken in conjunction with the accompanying drawings.

### BRIEF DESCRIPTION OF THE DRAWINGS

FIG. 1 is a schematic, cross-sectional view of the power supply unit in accordance with an embodiment of the present invention, illustrating that the fan is in operation;

FIG. 2 is a schematic, cross-sectional view illustrating that the fan in the power supply unit is not in operation;

FIG. 3 is a flow chart showing the method for cooling the batteries in accordance with an embodiment of the present invention;

FIG. 4 is a cross-sectional, perspective view of the case employed in the power supply unit in accordance with an embodiment of the present invention;

FIG. 5 is a cross-sectional, perspective view showing an alternative example of the case; and

FIG. 6 is a cross-sectional view showing another example of the case.

### DETAILED DESCRIPTION OF THE PREFERRED EMBODIMENTS

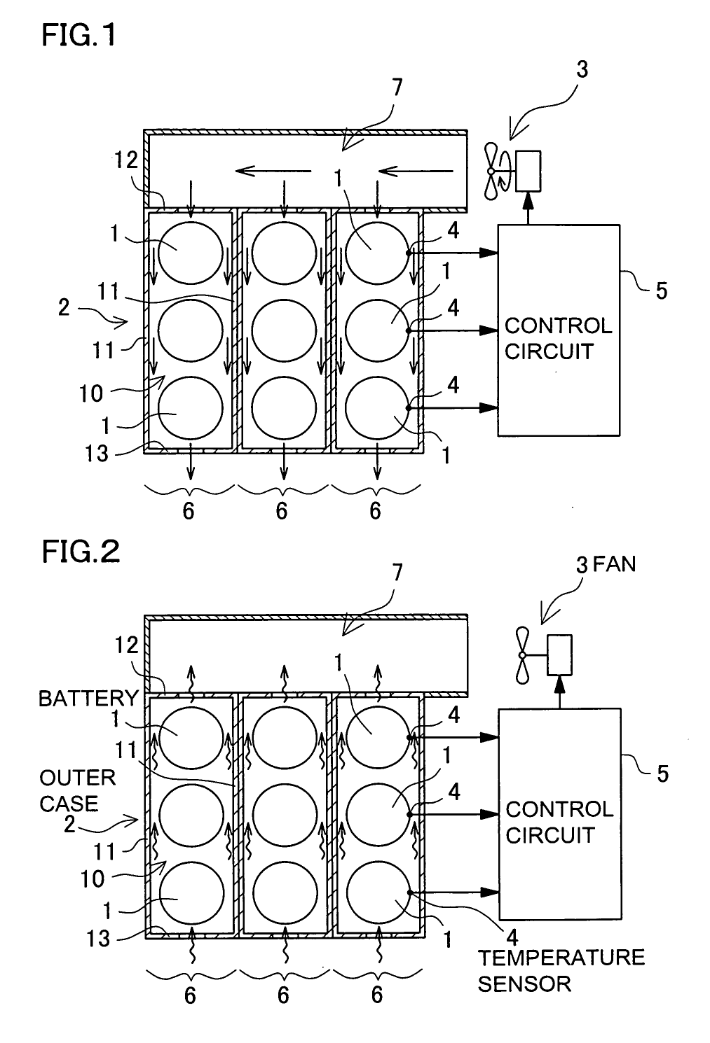

A power supply unit shown in FIGS. 1 and 2 includes a plurality of batteries 1 disposed up and down within a case 2, a fan 3 for forcibly blowing cooling air from top to bottom within the case 2 to cool the batteries 1, a temperature sensor 4 for detecting a temperature of the batteries 1 contained within the case 2, and a control circuit 5 for controlling operation of the fan 3 by means of a signal fed out of the temperature sensor 4.

With the above-described power supply unit, when a battery temperature reaches above a set value of temperature, the control circuit 5 starts operating the fan 3 to cool the batteries 1, and when a battery temperature is below the set value of temperature, the circuit 5 stops operating the fan 3 to retain the batteries 1 at a predetermined temperature.

When the fan 3 is in operation, as shown in FIG. 1, the power supply unit forcibly blows the cooling air from top to bottom within the case 2 so as to cool the batteries 1. When the fan 3 is not in operation, the batteries 1 are subjected to natural heat radiation, so that the batteries 1 may be cooled under the effect of air convection as indicated by an arrow in FIG. 2. In a state of the natural heat radiation where the fan 3 is not in operation, the temperature of the batteries 1 becomes lower in the lower tier and higher in the upper tier. This is because when the batteries 1 are subjected to the natural heat radiation, an temperature of the air rising up under the effect of convection is gradually elevated through being warmed up by the batteries 1, as indicated by an arrow. In other words, the battery 1 in the lower tier is cooled by the lower-temperature air, while the battery 1 in the upper tier is cooled by the higher-temperature air. As a result, when the fan 3 is not in operation, the battery temperature in the upper tier becomes higher.

Conversely, as shown in FIG. 1, when the fan 3 operates to forcibly blow cooling air from top to bottom, the battery temperature in the upper tier becomes lower than the battery temperature in the lower tier. This is because the battery 1 in the upper tier is cooled by lower-temperature air, while the battery 1 in the lower tier is cooled by higher-temperature air which has been warmed up by the battery 1 in the upper tier. Thus, in the case of a power supply unit where a plurality of batteries 1 are disposed in an upper-and-lower, multi-tier manner, with the air being forcibly blown from top to bottom as shown in FIG. 1, the battery temperature in the upper tier becomes higher when the fan 3 is not in operation, and the battery temperature in the lower tier becomes higher when the fan 3 is in operation, so that there occurs a temperature difference between the upper and lower batteries 1.

The power supply unit in accordance with the present invention is so designed as to reduce the temperature difference between the upper and lower batteries 1 to minimum by maneuvering such a phenomenon that the temperature difference is reversed when the fan 3 is in operation and when not in operation. That is to say, when the temperature difference between the upper and lower batteries reaches above a set value, as detected by the temperature sensor 4, the control circuit 5 works to stop the operation of the fan 3 while the fan 3 is in operation. When the fan 3 is in operation and a temperature difference occurs between the upper and lower batteries 1, the battery temperature in the upper tier becomes lower and the battery temperature in the lower tier becomes higher. In this state, when the fan 3 stops operation, there occurs natural heat radiation which works to cool the battery 1 in the lower tier more efficiently than the battery 1 in the upper tier. With this mechanism, the lower battery 1 with an elevated temperature can be cooled more quickly than the upper battery 1, thus resulting in minimizing the temperature difference between the upper and lower batteries 1.

Conversely, the fan 3 starts operation when the temperature difference between the upper and lower batteries 1 reaches above a set value while the fan 3 is not in operation. When the fan 3 stops operation and there occurs a temperature difference between the upper and lower batteries 1, the battery temperature in the lower tier becomes lower, while the battery temperature in the upper tier becomes higher. In this state, when the fan 3 starts operation, the batteries 1 are forcibly cooled by the cooling air blown from top to bottom, so that the upper battery 1 is cooled more efficiently than the lower battery 1. In this manner, the upper battery 1 with an elevated temperature can be cooled more quickly than the lower battery 1, resulting in minimizing the temperature difference between the upper and lower batteries 1.

The temperature sensor 4 is needed to detect battery temperatures both in the upper tier and in the lower tier. The power supply unit shown in FIG. 1 is provided with the temperature sensors 4, each of which detects a battery temperature in each tier. The power supply unit carries the advantage that the fan 3 performs a cooling operation when a battery temperature in any given tier reaches above a set value. It should be noted that the power supply unit can also be provided with a respective temperature sensor that is designed to detect a battery temperature in the uppermost tier and in the lowermost tier, instead of detecting battery temperatures in all the tiers.

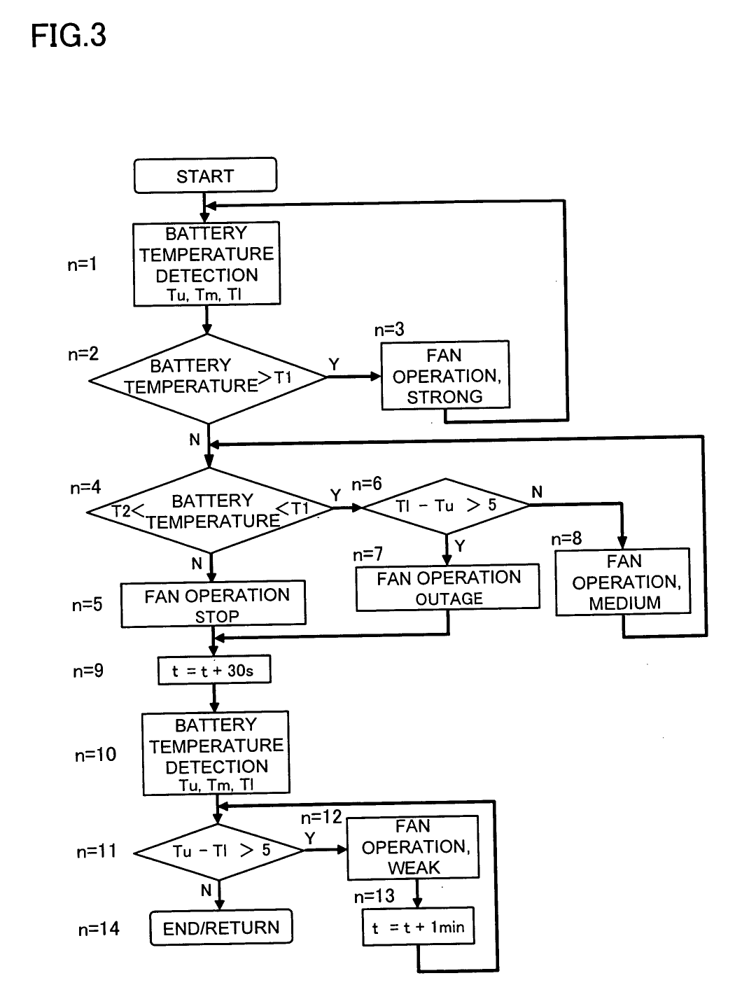

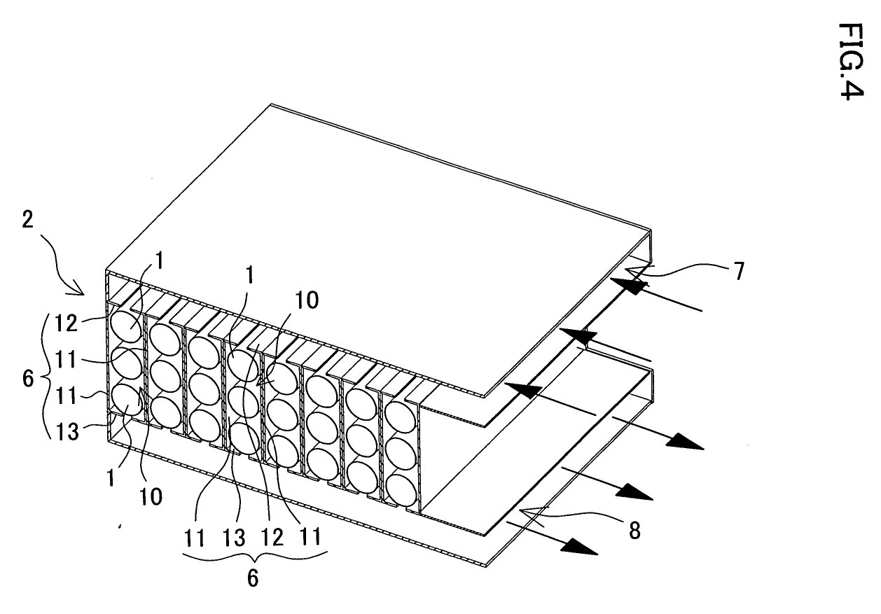

The control circuit 5 detects a battery temperature, and when the temperature of the batteries 1 reaches above a set value of temperature, the fan 3 starts operation to forcibly cool the batteries 1 down to a predetermined temperature. Additionally, as shown in the flow chart in FIG. 3, the control circuit 5 controls operation of the fan 3 in the under-mentioned steps in order to minimize a temperature difference between the upper and lower batteries 1.

Step of n=1

The temperature sensors 4 positioned at upper, middle, and lower tiers detect battery temperature (Tu, Tm, Tl) in each tier, respectively. “Tu” designates the battery temperature in the upper tier, “Tm” the battery temperature in the middle tier, and “Tl” the battery temperature in the lower tier.

Step of n=2

A battery temperature is compared with a first, set value of temperature (T1). The first, set value of temperature (T1) is the maximum temperature for the battery, which is a temperature where the battery temperature is kept lower than this temperature, being set at 45° C. for example.

Step of n=3

The fan 3 starts operation when any of the battery temperatures (Tu, Tm, Tl) is higher than the first, set value of temperature (T1). At this stage, the fan 3 operates at a higher speed to allow the battery temperatures (Tu, Tm, Tl) to be lowered quickly. A feedback loop will be established within the steps of n=2 and n=3 until all the battery temperatures (Tu, Tm, Tl) reach below the first, set value of temperature (T1). During this process, the fan 3 operates in a “strong” mode to forcibly cool the batteries 1 by means of cooling air.

Step of n=4

When none of the battery temperatures (Tu, Tm, Tl) is higher than the first, set value of temperature (T1), that is, when all the battery temperatures are lower than the first, set value of temperature (T1), it is so designed as to determine whether any of the battery temperatures (Tu, Tm, Tl) is lower than the first, set value of temperature (T1) and also whether any of the battery temperatures (Tu, Tm, Tl) is higher than a second, set value of temperature (T2). The second, set value of temperature (T2) is set to be lower than the first, set value of temperature (T1), for example, at 35° C.

Step of n=5

When all the battery temperatures (Tu, Tm, Tl) are lower than the second, set value of temperature (T2), the fan 3 stops operation, determining that the battery temperatures (Tu, Tm, Tl) are sufficiently low.

Step of n=6

In this step, when any of the battery temperatures (Tu, Tm, Tl) is lower than the first, set value of temperature (T1) and also higher than the second, set value of temperature (T2), it is so designed as to determine whether the battery temperature in the lower tier (Tl) minus the battery temperature in the upper tier (Tu) is larger than 5° C.

Step of n=7

When the battery temperature in the lower tier (Tl) minus the battery temperature in the upper tier (Tu) is larger than 5° C., the fan 3 stops operation after determining that the temperature difference within the batteries 1 is too large. When the fan 3 stops operation, the lower battery 1 with a higher temperature is cooled efficiently, allowing the temperature difference to be reduced.

Step of n=8

When the battery temperature in the lower tier (Tl) minus the battery temperature in the upper tier (Tu) is smaller than 5° C., the operation of the fan 3 is switched from a “strong” mode to a “medium” mode after determining that the temperature difference within the batteries 1 is small, and a feedback loop is established with the step of n=4.

Later, a feedback loop is established within the steps of n=4, n=6, and n=8 until all the battery temperatures (Tu, Tm, Tl) reach below the second, set value of temperature (T2) or until the battery temperature in the lower tier (Tl) minus the battery temperature in the upper tier (Tu) becomes larger than 5° C. During this stage, the fan 3 is in operation and the batteries 1 are cooled by the blown cooling air. The fan 3, however, operates in a “medium” mode, because all the battery temperatures (Tu, Tm, Tl) are lower than 45° C. which is the first, set value of temperature.

The fan 3 stops operation when all the battery temperatures (Tu, Tm, Tl) become lower than the second, set value of temperature (T2) or when the battery temperature in the lower tier (Tl) minus the battery temperature in the upper tier (Tu) becomes larger than 5° C.

Steps of n=9, 10, 11

Awaiting for a period of 30 seconds, as measured with a timer, after the fan 3 has stopped operation, the battery temperature (Tu, Tm, Tl) in each tier is detected to determine whether the battery temperature in the upper tier (Tu) minus the battery temperature in the lower tier (Tl) has become larger than 5° C. Since the battery temperature in the upper tier (Tu) becomes higher than the battery temperature in the lower tier (Tl) when the fan 3 is not in operation, it is determined whether the temperature difference between “Tu” and “Tl” is larger than 5° C. which is a set value of temperature.

Steps of n=12, 13, 14

In these steps, when the battery temperature in the upper tier (Tu) minus the battery temperature in the lower tier (Tl) is larger than 5° C., the fan 3 operates, and a feedback loop is established with the step of n=11 one minute later.

Since the fan 3 forcibly blows the cooling air from top to bottom, the battery temperature in the upper tier (Tu) with an elevated temperature is lowered more quickly than the battery temperature in the lower tier (Tl), so that the temperature difference between the upper and lower batteries 1 becomes smaller, and the fan 3 stops operation. In this state, the fan 3 continues to operate in a “weak” mode, enabling the batteries 1 to be less consumed. Also, when the fan 3 operates in a “weak” mode, a difference in a cooling effect on the upper and lower batteries 1 is large enough to quickly minimize the temperature difference between the upper and lower batteries 1 while keeping a power consumption small.

A power supply unit mounted to a vehicle is so designed as to establish a feedback loop in the steps of n=1 through n=14 when an ignition switch is switched on, so that a battery temperature is made lower than a set value of temperature and also a temperature difference within the batteries 1 is made smaller than a set value. Additionally, the power supply unit for a vehicle establishes the above-mentioned feedback loop in the steps of n=1 through n=14 at certain time intervals when the ignition switch is switched off as well, so that the temperature difference within the batteries 1 may be made smaller.

In the case of a power supply unit mounted to a vehicle, when an ignition switch is switched off after the battery 1 has been charged closer to a state fully charged with a large current, a difference between the battery temperature in the upper tier and the battery temperature in the lower tier may sometimes become considerably large as the time elapses. For example, when five to ten hours elapse after the ignition switch has been switched off, the difference between the battery temperature in the upper tier and the battery temperature in the lower tier may sometimes become considerably large. This is because a temperature difference is caused to be large by natural convection which occurs in the upward direction after the ignition switch has been switched off, with the battery temperature in the lower tier being lowered while the battery temperature in the upper tier is not decreased as compared to the battery temperature in the lower tier. In order to prevent such a disadvantage, the power supply unit mounted to a vehicle can be so designed as to control operation of the fan 3 in order to allow the temperature difference within the batteries 1 to stay within a set value by utilizing a method called a “wake-up”, in which a battery temperature is detected in the above-described steps at certain time intervals, for example on every two hours after the ignition switch has been switched off.

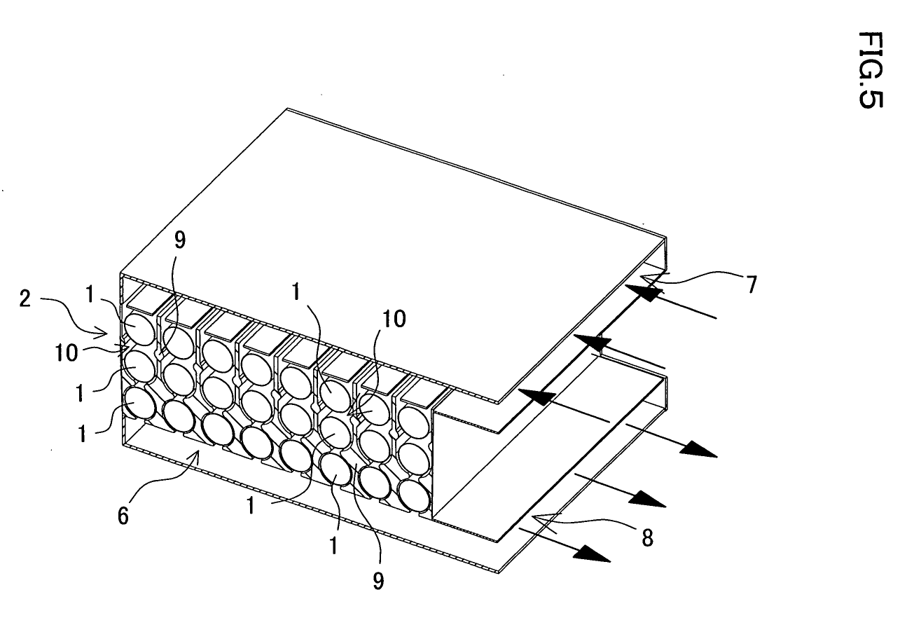

In the power supply unit, as shown in FIG. 4, a plurality of holder cases 6 are arranged horizontally which contain the batteries 1 in an upper-and-lower, multi-tier manner, with the an inlet duct 7 over the holder case 6 and with an outlet duct 8 beneath the holder case 6, so that the batteries 1 may be forcibly cooled by a fan (not shown) connected to the inlet duct 7. The power supply unit shown in the drawings has a plurality of batteries 1 contained within the holder case 6. Being in a form of a battery module in which a plurality of unit cells are linearly interconnected in series, each battery 1 is contained in the holder case 6. In the inventive power supply unit, however, the battery does not necessarily have to be contained within the holder case in a form of a battery module, but the battery may be contained in a form of unit cells as well. The plurality of battery modules contained in each individual holder case 6 are interconnected with each other in series. To add, the battery modules within the holder case can also be connected in a series-to-parallel arrangement.

The power supply unit in the drawings has the inlet duct 7 provided over the holder case 6 and the outlet duct 8 provided beneath the holder case 6, so that the batteries 1 are cooled by the cooling air forcibly blown by the fan, from the inlet duct 7 through the inside of the holder case 6 to the outlet duct 8, that is to say, by the cooling air blown from top to bottom within the holder case 6.

As shown in FIG. 4, the power supply unit having a plurality of holder cases 6 arranged horizontally into an outer case 2 is capable of adjusting an amount of output voltage by altering the number of the holder cases 6. This is possible because the output voltage can be increased by increasing the number of the laterally arranged and interconnected holder cases 6 and the number of the batteries 1 interconnected in series. The inventive power supply unit, however, does not necessarily have to have a plurality of holder cases interconnected to form an outer case. For example, as shown in FIG. 5, a single holder case 6 may be compartmentalized by partitions 9 into a plurality of enclosed compartments 10, so that the batteries 1 may also be contained in three or more tiers within each individual enclosed compartment 10.

Although not shown, the power supply unit has an end plate fixed to the holder case in such a manner that the plate is respectively positioned in contact with opposite end surfaces of the battery. The end plate is formed using an insulating material such as plastic, and connects a bus-bar (not shown), in a predetermined position, which is fixed to an electrode terminal provided on the opposite ends of the battery. The bus-bar is a metallic plate for interconnecting the adjoining batteries in series. The end plate is fixed to the holder case in a predetermined position by threadedly fixing the bus-bar to the battery.

As shown in FIGS. 4 and 5, the holder case 6 has a plurality of horizontally-postured batteries 1 contained in a vertical arrangement. Each battery 1 is contained within the holder case 6 in a form of a battery module in which a plurality of unit cells are linearly interconnected in series. The battery module have, for example, five to six unit cells interconnected linearly. However, the battery can also have four or less unit cells or seven or more unit cells interconnected. The battery is a nickel-hydrogen battery. However, the battery can also be other kinds of secondary battery such as a lithium-ion battery and nickel-cadmium battery. The illustrated battery module is formed in a columnar state, with cylindrical unit cells being linearly interconnected.

The holder case 6 shown in FIG. 4 has the batteries 1 contained in three tiers inside a pair of opposed walls 11; inlet and outlet sides of the pair of opposed walls 11 are enclosed with inlet and outlet walls 12 and 13; an enclosed compartment 10 is formed with the pair of opposed walls 11, the inlet and outlet walls 12 and 13; and the horizontally-postured batteries 1 are contained within the enclosed compartment in an upper-and-lower, multi-tier manner.

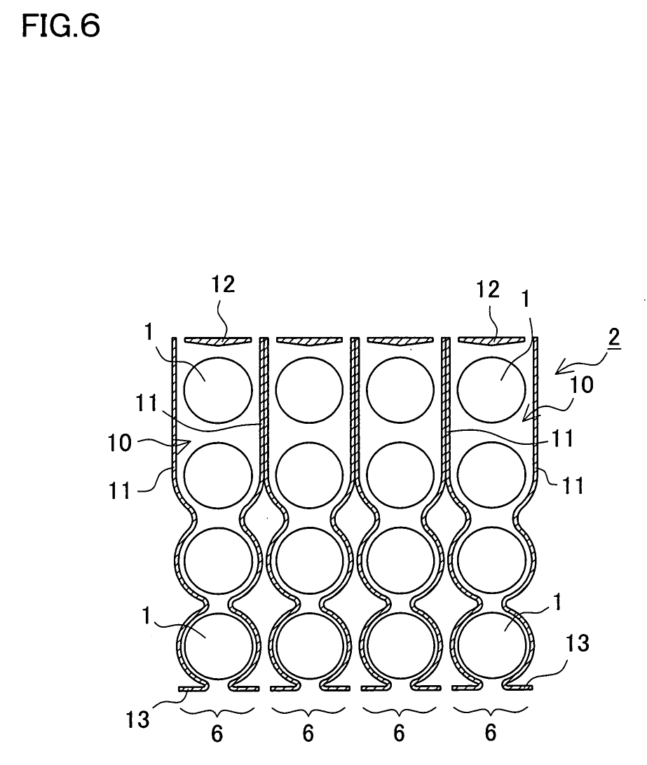

As shown in FIG. 6, the holder case 6 can have the batteries 1 contained in four tiers, and even in five or more tiers. Also, while the above-illustrated power supply unit has the batteries arranged in a single column, being vertically separated from each other, within each individual holder case 6, it is also possible to lay out the batteries in a plurality of columns or in a vertically separated, staggered arrangement.

The power supply unit shown in FIGS. 5 and 6 is so structured and arranged that forcibly blown cooling air cools the upper and lower batteries 1 down to a uniform temperature. The power supply unit is capable of reducing the temperature difference between the upper and lower batteries 1 while the fan operates to blow the cooling air. The power supply unit thus structured is capable of cooling the upper and lower batteries 1 down to a uniform temperature by speeding up the fan rotation, and is also capable of differentiating a cooling effect on the upper and lower batteries by slowing down the fan rotation. In other words, the fan rotation can be slowed down to cool the upper battery 1 more efficiently than the lower battery 1. When the fan rotation is slowed down to reduce a flow speed of the cooling air, the upper battery 1 is cooled effectively by colder cooling air, while the lower battery 1 is cooled by the cooling air which has been warmed up by the upper battery 1, thus resulting in a reduced cooling effect on the lower battery 1. Because of this mechanism, the slowed fan rotation enables the cooling effect to be differentiated between the upper and lower batteries 1.

Furthermore, in the power supply unit shown in FIGS. 5 and 6, when the fan 3 stops operation, the lower battery 1 is less likely to be cooled than the upper battery 1, so that the battery temperature becomes higher in the lower tier than in the upper tier. When reaching such a state, the fan 3 starts operation to cool the upper battery 1 more efficiently than the lower battery 1, thus resulting in a reduced temperature difference.

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the spirit and scope of the invention as defined in the appended claims. The present application is based on Application No. 2005-283114 filed in Japan on Sep. 28, 2005, the content of which is incorporated herein by reference.

What is claimed is:

1. A power supply unit comprising:
a case;
a plurality of batteries disposed up and down in a plurality of tiers within the case;
a fan for forcibly blowing cooling air from top to bottom within the case to cool the batteries;
a temperature sensor for detecting a temperature of the batteries; and
a control circuit for controlling operation of the fan by means of a signal fed out of the temperature sensor,
wherein the temperature sensor detects an battery temperature in the upper tier indicative of the temperature of the battery in a upper tier and a battery temperature in the lower tier indicative of the temperature of the battery in a lower tier, and further the control circuit controls the operation of the fan on a basis of a temperature difference between the battery temperature in the upper tier and the battery temperature in the lower tier.

2. The power supply unit as recited in claim 1 wherein when the temperature difference between the battery temperature in the upper tier and the battery temperature in the lower tier is detected to have reached above a set value, the control circuit stops the fan being in operation to cool the batteries through natural heat radiation.

3. The power supply unit as recited in claim 2 wherein when the battery temperature in the lower tier is detected to have become higher than the battery temperature in the upper tier as compared to a set value, the control circuit stops the fan being in operation to cool the batteries through the natural heat radiation.

4. The power supply unit as recited in claim 1 wherein when the temperature difference between the battery temperature in the upper tier and the battery temperature in the lower tier has reached above a set value, the control circuit starts the fan being out of operation to forcibly cool the batteries with cooling air blown by the fan.

5. The power supply unit as recited in claim 4 wherein when the battery temperature in the upper tier has become higher than the battery temperature in the lower tier as compared to a set value, the control circuit starts the fan being out of operation to forcibly cool the batteries with the cooling air blown by the fan.

6. The power supply unit as recited in claim 1,
wherein when the temperature difference between the battery temperature in the upper tier and the battery temperature in the lower tier is detected to have reached above a set value, the control circuit stops the fan being in operation to cool the batteries through the natural heat radiation, and
wherein when the temperature difference between the battery temperature in the upper tier and the battery temperature in the lower tier has reached above a set value, the control circuit starts the fan being out of operation to forcibly cool the batteries with the cooling air blown by the fan.

7. The power supply unit as recited in claim 6,
wherein when the battery temperature in the lower tier is detected to have become higher than the battery temperature in the upper tier as compared to a set value, the control circuit stops the fan being in operation to cool the batteries through the natural heat radiation, and
wherein when the battery temperature in the upper tier is detected to have become higher than the battery temperature in the lower tier as compared to a set value, the control circuit starts the fan being out of operation to forcibly cool the batteries with the cooling air blown by the fan.

8. The power supply unit as recited in claim 1 wherein the batteries are disposed up and down in a plurality of tiers within the case, and correspondingly the temperature sensor detects battery temperatures in all the tiers.

9. The power supply unit as recited in claim 1 wherein the batteries are disposed up and down in a plurality of tiers within the case, and correspondingly the temperature sensor detects the battery temperature in the uppermost tier as indicative of the battery temperature in the upper tier and the battery temperature in the lowermost tier as indicative of the battery temperature in the lower tier.

10. The power supply unit as recited in claim 1 wherein when a temperature of any of the batteries becomes higher than a set value of temperature, the control circuit starts the fan being out of operation to forcibly cool the batteries.

11. A method for cooling a battery, in which method temperatures of a plurality of batteries disposed up and down in a plurality of tiers within a case are detected by a temperature sensor, operation of a fan is controlled by means of a battery temperature detected by the temperature sensor, and the batteries is cooled by the cooling air forcibly blown by the fan,
wherein an battery temperature in the upper tier and a battery temperature in the lower tier are detected, and a temperature difference between the battery temperature in the upper tier and the battery temperature in the lower tier which are detected is compared to a set value, so that the operation of the fan is controlled, based on the temperature difference between the batteries.

12. The method for cooling a battery as recited in claim 11 wherein when the temperature difference between the battery temperature in the upper tier and the battery temperature in the lower tier reaches above a set value, the fan being in operation stops and the batteries are cooled through natural heat radiation.

13. The method for cooling a battery as recited in claim 12 wherein when the battery temperature in the lower tier becomes higher than the battery temperature in the upper tier as compared to a set value, the fan being in operation stops and the batteries are cooled through the natural heat radiation.

14. The method for cooling a battery as recited in claim 11 wherein when the temperature difference between the battery temperature in the upper tier and the battery temperature in the lower tier reaches above a set value, the fan being out of operation starts and the batteries are forcibly cooled by the cooling air blown by the fan.

15. The method for cooling a battery as recited in claim 14 wherein when the battery temperature in the upper tier becomes higher than the battery temperature in the lower tier as compared to a set value, the fan being out of operation starts and the batteries are forcibly cooled by the cooling air blown by the fan.

16. The method for cooling a battery as recited in claim 11 wherein when the temperature difference between the battery temperature in the upper tier and the battery temperature in the lower tier reaches above a set value, the fan being in operation stops and the batteries are cooled through the natural heat radiation, and
wherein when the temperature difference between the battery temperature in the upper tier and the battery temperature in the lower tier reaches above a set value, the fan being out of operation starts and the batteries are forcibly cooled by the cooling air blown by the fan.

17. The method for cooling a battery as recited in claim 16 wherein when the battery temperature in the lower tier becomes higher than the battery temperature in the upper tier as compared to a set value, the fan being in operation stops and the batteries are cooled through the natural heat radiation, and
wherein when the battery temperature in the upper tier becomes higher than the battery temperature in the lower tier as compared to a set value, the fan being out of operation starts and the batteries are forcibly cooled by the cooling air blown by the fan.

18. The method for cooling a battery as recited in claim 11 wherein when a temperature of any of the batteries reaches above a set value, the fan being out of operation starts and the batteries are forcibly cooled.

19. The method for cooling a battery as recited in claim 11 wherein when a temperature of all of the batteries is lower than the first, set value of temperature and also any of the battery temperatures is higher than a second, set value of temperature which is set to be lower than the first, set value of temperature, and when the temperature difference between the battery temperature in the upper tier and the battery temperature in the lower tier reaches above a set value, the fan being in operation stops and the batteries are cooled through the natural heat radiation.

20. The method for cooling a battery as recited in claim 11 wherein when a temperature of all of the batteries is lower than the first, set value of temperature and also any of the battery temperatures is higher than a second, set value of temperature which is set to be lower than the first, set value of temperature, and when the temperature difference between the battery temperature in the upper tier and the battery temperature in the lower tier is smaller than a set value, the fan being out of operation starts and the batteries are forcibly cooled by the cooling air blown by the fan.
